(19) United States
(12) Patent Application Publication
(10) Pub. No.: US 2003/0051316 A1
(43) Pub. Date: Mar. 20, 2003

(54) Deformable grip for a writing implement

(76) Inventor: Boyd I. Willat, Los Angeles, CA (US)

Correspondence Address: Stuart O. Lowry, KELLY BAUERSFELD LOWRY & KELLEY, LLP, Suite 1650, 6320 Canoga Avenue, Woodland Hills, CA, 91367, US

(21) Appl. No.: 10/262,668

(22) Filed: Oct. 2, 2002

Related U.S. Application Data
(63) Continuation-in-part of application No. 10/218,248, filed on Aug. 13, 2002.
(60) Provisional application No. 60/311,923, filed on Aug. 13, 2001.

(51) Int. Cl. B62B 1/00

(52) U.S. Cl. 16/430

(57) ABSTRACT

A deformable grip for a writing implement, and related production method, are provided wherein the grip resiliently conforms to individualized anatomical contours and preferences, thereby providing enhanced user comfort with reduced fatigue. The deformable grip includes a resilient outer sleeve mounted on the writing implement in a position for manual grasping during normal use, as by fingertip grasping, wherein this outer sleeve closes an internal cavity containing a plurality of shape-deformable balls having sufficient resilience to provide the sleeve with a deformable tactile feel during normal use. These resilient balls are sufficiently deformable to accommodate injection into the cavity through a hollow needle passed through a small puncture port formed in the sleeve, followed by return to a normal size and shape sufficiently large to prevent backflow leakage through the puncture port to the sleeve exterior.

### BACKGROUND OF THE INVENTION

This application in a continuation-in-part of U.S. Ser. No. 10/218,248, filed Aug. 13, 2002, which in turn claims the benefit of U.S. Provisional Application No. 60/311,923, filed Aug. 13, 2001.

This invention relates generally to improvements in writing implements of the general type including inks pens, pencils, felt tip markers, and the like. More specifically, this invention relates to an improved deformable grip responsive to user fingertip pressure or the like to assume a highly comfortable and low fatigue geometric configuration.

A wide variety of different kinds of writing implements are well known to include many different types of ink pens, pencils, and various other forms of marking implements. Such writing implements typically comprise a generally cylindrical or barrel-like elongated body carrying a marking medium, for example, a ball point pen cartridge having a porous ball writing tip or nib exposed at the end of a long and thin ink-containing cylinder. The implement body is traditionally grasped by the fingertips at a position near the writing tip to facilitate implement manipulation during movement of the writing tip over the surface of a marking medium such as paper or the like.

The generally cylindrical body of a writing implement may be formed in a wide variety of different sizes and specific geometric shapes. In this regard, it is generally recognized that the size and shape of most writing implements is not adapted for prolonged use without experiencing a relatively high degree of user fatigue and discomfort, sometimes referred to as writer's cramp.

In attempts to alleviate this situation, many writing implements are provided with contoured grip surfaces of different sizes and shapes, some of which incorporate complex molded configurations aimed at approximating the anatomical contours of a writer's fingertips during normal grasping of the writing implement. However, such premolded grip surfaces have achieved only limited success in relieving writer's fatigue since, among other reasons, the grip surface is unable to match the differing anatomical shapes and pen grasping techniques of different individuals.

Some writing implements have been provided with a deformable or resilient grip as an alternative approach to achieving enhanced comfort and reduced fatigue during use. For the most part, these deformable grips include a flexible or resilient outer sleeve structure mounted onto the body of a writing implement and defining an internal chamber or cavity containing a resilient filler material such as a flowable gel or putty or other fluid or fluid-based substance chosen to provide at least some yield in response to fingertip pressure when the writing implement is gripped. In many such deformable grips, the resilient grip structure tends to spring back to its initial nondeformed state when the grip is released by the writer. In other designs, the deformable grip exhibits memory characteristics wherein the user-deformed shape is retained following release of the grip. One improved deformable grip is shown and described in U.S. Pat. No. 5,000,599, wherein the grip initially retains a custom fit shape conforming with the anatomical contours of a particular user's fingertips, but thereafter slowly returns substantially to an initial nondeformed shape.

While deformable grips provide significant benefits with respect to enhanced user comfort and reduced fatigue, such grips are susceptible to undesirable leakage of the flowable filler material from the internal chamber or cavity defined by the outer sleeve. In this regard, special attention is require to properly close and seal this internal chamber or cavity subsequent to placement of the filler material therein, in order to prevent backflow leakage of the flowable filler material and related loss of the desired deformable and resilient grip characteristics. Moreover, notwithstanding proper sealing of this internal chamber or cavity, backflow leakage of the flowable substance can still occur in the event that the outer sleeve is pierced or punctured by a sharp object.

There exists, therefore, a need for further improvements in and to deformable grips, for use with writing implements of the type having a flowable resilient filler material contained within an internal chamber or cavity defined by a resilient outer sleeve, and wherein undesired backflow leakage of the filler material is substantially precluded. The present invention fulfills these needs and provides further related advantages.

### SUMMARY OF THE INVENTION

In accordance with the invention, an improved deformable grip is provided for use with a writing implement to provide a soft and resilient structure for shape adaptation in conformance with the anatomical contours and particular grasping technique of an individual user. The deformable grip is designed to assume a custom fit configuration when the implement is grasped or gripped by the user for enhanced user comfort and control with reduced fatigue. The deformable grip comprises an outer resilient and flexible sleeve mounted on the implement to define an internal chamber or cavity which is filled at least partially with a flowable resilient filler material comprising a quantity of resilient balls having sufficient shape elasticity to provide the sleeve with a selected and deformable tactile feel during normal use. These resilient balls are sufficiently deformable to accommodate injection into the sleeve cavity through a hollow needle passed through a small puncture port formed in the sleeve, followed by return to a normal size and shape sufficiently large to prevent backflow leakage through the puncture port to the sleeve exterior.

In a preferred form, the outer sleeve comprises a generally cylindrical component formed from a resilient and flexible silicon-based elastomer or the like. This outer sleeve is assembled with an inner liner of generally cylindrical shape and formed from a compatible elastomer for substantially sealed attachment to the sleeve to cooperatively define the internal chamber or cavity of generally annular cross sectional shape. The outer sleeve and inner liner are mounted onto the writing implement in a selected position for fingertip grasping during normal use of the implement. The internal chamber is then at least partially filled by injecting the resilient balls under pressure, as by use of syringe or the like, through a hollow injection needle passed through the outer sleeve via a small puncture port or the like formed therein. During this injection step, the resilient balls assume a narrow cross sectional size sufficiently small to pass through the injection needle, and thus also through the puncture port, into the internal chamber. However, within the internal chamber, the resilient balls return substantially to an initial nondeformed state each having a cross sectional size substantially in excess of the puncture port size. As a result, within the internal chamber, the resilient balls assume a size which prevents backflow leakage through the puncture port to the exterior of the outer sleeve, without requiring the puncture port to be sealed. Normal pressure applied via the outer sleeve to the resilient balls during use of the writing implement is inadequate to deform the balls sufficiently for backflow leakage through the puncture port.

In one preferred form, the resilient balls are formed from polyurethane foam each having a diametric size of about 1/32 inch. To facilitate injection through the hollow needle into the internal chamber, and to enhance flowability in response to fingertip pressure applied during normal use, the resilient balls may desirably be coated with a liquid silicon lubricant. During normal use of the writing implement, the puncture port formed in the outer sleeve normally exhibits sufficient self-sealing characteristics to prevent backflow leakage of any significant portion of the lubricant.

Other features and advantages of the invention will become more apparent from the following detailed description, taken in conjunction with the accompanying drawings which illustrate, by way of example, the principles of the invention.

### BRIEF DESCRIPTION OF THE DRAWINGS

The accompanying drawings illustrate the invention. In such drawings:

FIG. 1 is a perspective view illustrating a writing implement incorporating an improved deformable grip constructed in accordance with the present invention;

FIG. 2 is an enlarged fragmented perspective view of a portion of the writing implement of FIG. 1, with portions broken away to reveal construction details of the deformable grip;

FIG. 3 is an enlarged longitudinal sectional view taken generally on the line 3-3 of FIG. 2;

FIG. 4 is an enlarged transverse sectional view taken generally on the line 4-4 of FIG. 2;

FIG. 5 is a fragmented perspective view depicting injection of a filler material into the deformable grip; and

FIG. 6 is an enlarged and fragmented perspective showing the injection of the filler material in more detail.

### DETAILED DESCRIPTION OF THE PREFERRED EMBODIMENT

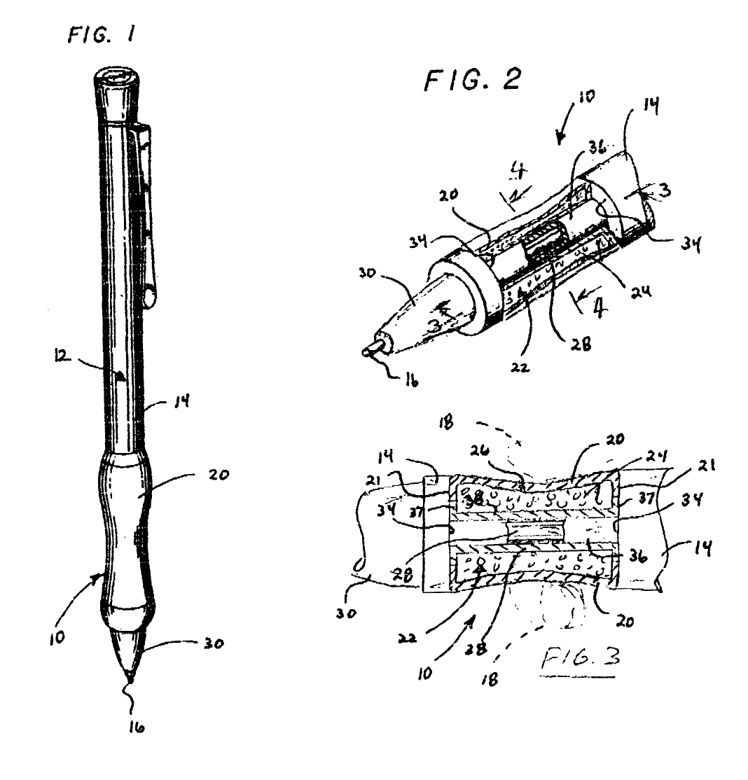

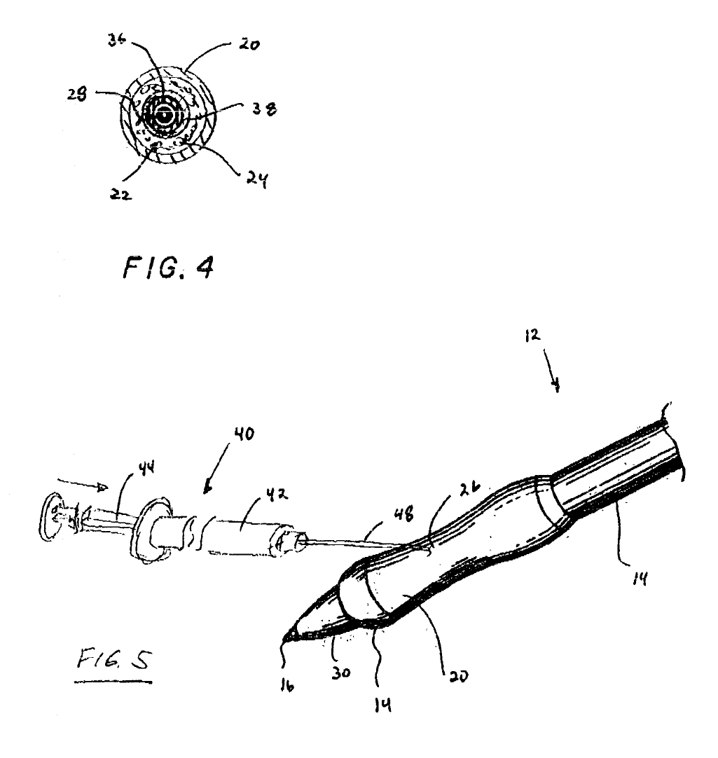

As shown in the exemplary drawings, an improved deformable grip referred to generally in FIGS. 1-6 by the reference numeral 10 is provided on a manually grasped writing implement 12. The deformable grip 10 is designed to flexibly and resiliently change shape in response to applied manual pressure during normal implement use, so that the grip 10 conforms geometrically to the anatomical contours and particular grasping technique of an individual user. In this manner, the deformable grip 10 provides significantly enhanced user comfort and reduced user fatigue.

The deformable grip 10 of the present invention is shown in the exemplary drawings for use with the writing implement 12. The illustrative drawings show the deformable grip 10 mounted on an elongated body 14 of the writing implement 12 generally at or near the end adjacent a writing tip or nib 16. The grip 10 is positioned for normal grasping by a writer's fingertips 18 (FIG. 3) as the writing implement 12 is held and manipulated during normal use for applying markings to a selected substrate or surface such as a piece of paper (not shown). In general terms, the deformable grip 10 provides a cushioned structure which advantageously conforms when grasped to a custom or personalized shape fit.

In accordance with a primary aspect of the invention, this cushioned structure comprises a resilient and flexible outer sleeve 20 defining an internal chamber or cavity 22 which is at least partially filled with a flowable resilient filler material 24 in the form of resilient balls. These resilient balls 24 are formed from a selected compressible elastomer or the like capable of assuming a small cross sectional size for injection into the sleeve cavity 22 through via a small port 26, but thereafter expand to a substantially larger cross sectional size and shape so that backflow leakage of the resilient balls through the port 26 to the exterior of the writing implement is substantially precluded. Within the sleeve cavity 22, the resilient balls 24 cooperate with the flexible sleeve 20 to provide the deformable grip 10 with the desired soft and resilient tactile feel.

More particularly, and as shown in the illustrative drawings with respect to one preferred form of the invention, the body 14 of the writing implement 12 has an elongated and generally cylindrical shape with a hollow interior for receiving and supporting a marking medium 28 shown in the form of a ball point pen cartridge. A front end of this cartridge 28 protrudes through a contoured head 30 which can be generally cone-shaped to provide a relatively smooth transition from the cylindrical body 14 to the writing tip or nib 16 exposed through the head 30. In the case of a ball point pen cartridge, the writing tip 16 comprises a conventional porous writing ball for delivering ink from within the elongated cylindrical cartridge 28 to a writing surface such as paper. Alternately, it will be appreciated that other types of marking media may be used.

The body 14 of the writing implement 12 is further shaped to include a generally annular recess or gap formed therein at a position disposed generally at or near the head 30 at the front end thereof. This recessed gap is, in the preferred form, defined between a pair of axially spaced shoulders 34 and coaxially surrounds a central guide tube 36 of reduced diameter, through which the pen cartridge 28 extends. The axial length of this recessed gap may vary in accordance with the size and style of the writing implement, with an axial length on the order of about one to two inches being suitable for most applications.

The flexible resilient sleeve 20 has a generally cylindrical shape and is mounted on the body 14 of the writing implement for substantially closing this gap 32, to provide a substantially smooth-surfaced and attractive-appearing continuation of the exterior surface of the body 14. In this regard, the flexible sleeve 20 may desirably incorporate a contoured or curved geometry blending smoothly with the body 14, as viewed best in FIG. 1. In a preferred form, the flexible sleeve 20 is constructed from a relatively thin rubber-based or deformable plastic or elastomer material, such as a silicon rubber having a relatively high tear strength to resist significant tearing or rupture during normal use. As shown in FIG. 3, the opposite ends of the sleeve 20 are down-turned to define short flanges 21 adapted for secure and substantially sealed attachment as by an adhesive or sonic welding to a mating pair of radially out-turned flanges 37 on a cylindrical inner liner 38 which is also formed from a selected rubber-based or deformable plastic type material. The outer sleeve 20 thus cooperates with the inner liner 38 to form a sealed bladder of generally annular shape defining the internal sleeve cavity 22, also of generally annular shape.

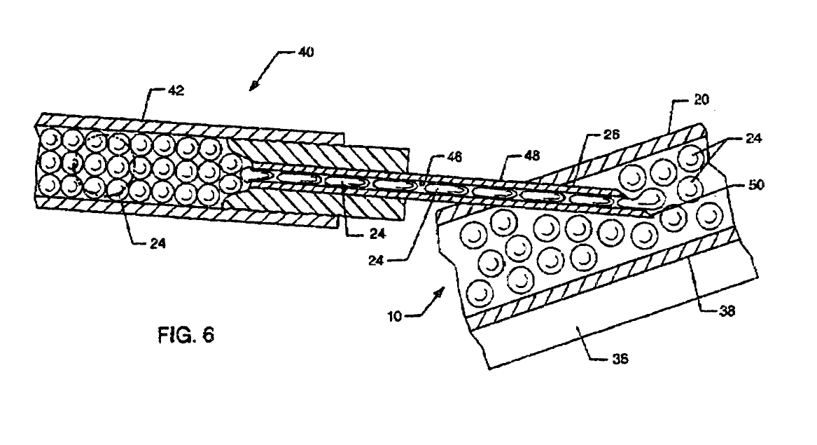

The assembled outer sleeve 20 and inner liner 38 are normally mounted onto the implement body 14 within the gap, prior to filling of the cavity 22 with the resilient balls 24. A syringe 40 (FIGS. 5 and 6) includes a barrel 42 loaded with a prescribed quantity of the resilient balls 24, with a plunger 44 slidably carried within the barrel 42 for pressure delivery of the balls 24 through a narrow bore passage 46 defined through a hollow injection needle 48 mounted at a front or nose end of the syringe barrel. This injection needle 48 includes a sharp tip 50 for puncturing or piercing the flexible sleeve 20 to form the small injection port 26 therein. The plunger 44 can then be advanced within the barrel 42 for applying a sufficient and relatively high pressure to the resilient balls 24, so that the balls 24 each deform to an elongated yet narrow cross sectional size for flow passage through the needle bore 46 into the sleeve cavity 22. FIG. 6 illustrates such deformation of the resilient balls 24 for essentially single file flow through the needle 48 into the sleeve cavity 22. Importantly, within the sleeve cavity 22, the applied pressure on the resilient balls 24 is substantially released to permit the balls to return substantially to their initial nondeformed and typically spheroid shape having a diametric size significantly greater than the size of the puncture port 26.

Within the sleeve cavity 22, the resilient balls 24 provide a resilient and deformable cushioned structure underlying the outer flexible sleeve 20, to thereby provide the desired soft tactile feel when the writing implement 12 is grasped and used in a normal manner. In this regard, the resilient balls 24 slide over one another and shift about within the sleeve cavity 22 to provide the desired deformation characteristics, and further wherein the resilient balls 24 exhibit a memory tendency to resiliently retain a customized deformed shape associated with a particular user. Such slide-shift movement of the balls 24 may be enhanced by lightly coating the balls with a liquid lubricant, such as a silicon lubricant which additionally assists is smooth flow of the balls 24 through the injection needle 48 into the sleeve cavity 22. Importantly, during this normal use, the resilient balls 24 are exposed to relatively low fingertip tactile pressure which is insufficient to deform the balls to fit through the puncture port 26. Accordingly, pursuant to one primary aspect of the invention, backflow leakage of the resilient balls 24 is effectively prevented by virtue of the ball size relative to the size of the puncture port 26, without requiring any special or additional sealing of the puncture port.

Although the resilient balls 24 may be formed from a variety of different elastomer or other materials having the appropriate size and shape elasticity, one preferred material comprises polyurethane foam balls having a diametric size of about 1/32 inch. Such resilient balls 24 may be lightly coated with a liquid-based silicon lubricant prior to injection into the sleeve cavity 22. After injection, such balls 24 and the associated lubricant will be retained within the cavity 22, substantially without any undesired leakage therefrom, without requiring sealed closure of the injection port 26.

A variety of further modifications and improvements in and to the deformable grip 10 of the present invention will be apparent to those persons skilled in the art. Accordingly, no limitation on the invention is intended by way of the foregoing description and accompanying drawings, except as set forth in the appended claims.

What is claimed is:

1. A writing implement, comprising:
a writing implement body; and
a deformable grip mounted on said body, said deformable grip including a resilient member defining at least one internal cavity, and a flowable filler material contained within and at least partially filling said at least one cavity, said flowable filler material comprising a plurality of bodies movable within said at least one cavity in response to tactile pressure.

2. The writing implement of claim 1 wherein said flowable filler material comprises a plurality of shape-deformable bodies.

3. The writing implement of claim 1 wherein said resilient member is formed from a flexible elastomer material.

4. The writing implement of claim 2 wherein said shape-deformable bodies comprise a compressible elastomer.

5. The writing implement of claim 2 wherein said shape-deformable bodies comprise elastomer balls.

6. The writing implement of claim 5 further including a lubricant carried by said elastomer balls.

7. The writing implement of claim 2 wherein said resilient member has an injection port formed therein, said shape-deformable bodies being sufficiently compressible for pressure-injection into said at least one cavity via said injection port, said shape-deformable bodies within said at least one cavity returning to an initial substantially uncompressed state having a size larger than the size of said injection port.

8. The writing implement of claim 1 wherein said resilient member comprises an outer resilient sleeve having a size and shape for mounting onto a manual implement, said sleeve and said manual implement cooperatively defining said at least one cavity.

9. The writing implement of claim 1 wherein said resilient member comprises an outer resilient sleeve assembled with an inner liner sleeve for cooperatively defining said at least one cavity.

10. A writing implement, comprising:
a writing implement body; and
a deformable grip mounted on said body, said deformable grip including a resilient member defining at least one internal cavity, and a flowable resilient filler material contained within and at least partially filling said at least one cavity, said flowable resilient filler material comprising a plurality of shape-deformable bodies movable within said at least one cavity in response to tactile pressure;
said resilient member further having an injection port formed therein, said shape-deformable bodies being sufficiently compressible for pressure-injection into said at least one cavity via said injection port, said shape-deformable bodies within said at least one cavity returning to an initial substantially uncompressed state having a size larger than the size of said injection port.

11. The writing implement of claim 10 wherein said shape-deformable bodies comprise a compressible elastomer.

12. The writing implement of claim 11 further including a lubricant carried by said shape-deformable bodies.
